(19) United States
(12) Patent Application Publication
(10) Pub. No.: US 2026/0106088 A1
(43) Pub. Date: Apr. 16, 2026

(54) CAPACITOR ELEMENT STRUCTURE, CAPACITOR ASSEMBLY PACKAGING STRUCTURE AND ELECTRONIC DEVICE

(71) Applicant: APAQ TECHNOLOGY CO., LTD., Miaoli County (TW)

(72) Inventors: DUEN-JEN CHENG, KAOHSIUNG CITY (TW); CHIEH LIN, HSINCHU COUNTY (TW)

(21) Appl. No.: 19/352,424

(22) Filed: Oct. 7, 2025

(30) Foreign Application Priority Data
Oct. 15, 2024 (TW) 113139062

(51) Int. Cl. H01G 9/10; H01G 9/035; H01G 9/055; H01G 9/145; H01G 9/26

(52) U.S. Cl. CPC H01G 9/10; H01G 9/035; H01G 9/055; H01G 9/145; H01G 9/26

(57) ABSTRACT

A capacitor element structure, a capacitor assembly packaging structure and an electronic device. The capacitor assembly packaging structure includes a capacitor assembly, an insulating package body and an electrode assembly. The capacitor assembly includes a plurality of capacitor element structures stacked in sequence and electrically connected to each other. The insulating package body is configured to encapsulate the capacitor element structures. The electrode assembly includes a first electrode structure and a second electrode structure that are configured to cooperate with the insulating package body and electrically connected to the capacitor element structure. Each of the capacitor element structures includes an oxide layer, the oxide layer has a plurality of micro recessed spaces that are irregularly concaved and arranged, and each of the micro recessed spaces is partially filled with an electrolyte substance.

### CROSS-REFERENCE TO RELATED PATENT APPLICATION

This application claims the benefit of priority to Taiwan Patent Application No. 113139062, filed on Oct. 15, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a capacitor, and more particularly to a capacitor element structure, a capacitor assembly packaging structure configured to use the capacitor element structure, and an electronic device configured to use the capacitor assembly packaging structure.

### BACKGROUND OF THE DISCLOSURE

Applications of capacitors include being widely used in home appliances, computer motherboards and peripherals, power supplies, communication products and automobiles. The capacitors are mainly used to provide functions such as filtering, bypassing, rectifying, coupling, blocking and transforming, and such capacitors have become an indispensable component in electronic products. However, there is still room for improvement in the related art of the capacitor.

### SUMMARY OF THE DISCLOSURE

In response to the above-referenced technical inadequacy, the present disclosure provides a capacitor element structure, a capacitor assembly packaging structure configured to use the capacitor element structure, and an electronic device configured to use the capacitor assembly packaging structure.

In order to solve the above-mentioned problems, one of the technical aspects adopted by the present disclosure is to provide a capacitor element structure, which includes a metal foil, an insulating limiting layer, a conductive polymer layer, a carbon paste layer and a silver paste layer. The metal foil has an oxide layer. The insulating limiting layer is configured to be disposed around the metal foil. The conductive polymer layer is configured to enclose a portion of the metal foil and contact the insulating limiting layer. The carbon paste layer is configured to enclose the conductive polymer layer and contact the insulating limiting layer. The silver paste layer is configured to enclose the carbon paste layer and contact the insulating limiting layer. The oxide layer has a plurality of micro recessed spaces that are irregularly concaved and arranged, and each of the micro recessed spaces is partially filled with an electrolyte substance.

In order to solve the above-mentioned problems, another one of the technical aspects adopted by the present disclosure is to provide a capacitor assembly packaging structure, which includes a capacitor assembly, an insulating package body and an electrode assembly. The capacitor assembly includes a plurality of capacitor element structures stacked in sequence and electrically connected to each other, and each of the capacitor element structures has a positive electrode portion and a negative electrode portion. The insulating package body is configured to encapsulate the capacitor element structures. The electrode assembly includes a first electrode structure and a second electrode structure, in which the first electrode structure is configured to cooperate with the insulating package body and electrically connected to the positive electrode portion of the capacitor element structure, and the second electrode structure is configured to cooperate with the insulating package body and electrically connected to the negative electrode portion of the capacitor element structure. Each of the capacitor element structures includes an oxide layer, the oxide layer has a plurality of micro recessed spaces that are irregularly concaved and arranged, and each of the micro recessed spaces is partially filled with an electrolyte substance.

In order to solve the above-mentioned problems, yet another one of the technical aspects adopted by the present disclosure is to provide an electronic device configured to use a capacitor assembly packaging structure. The capacitor assembly packaging structure includes a capacitor assembly, an insulating package body and an electrode assembly. The capacitor assembly includes a plurality of capacitor element structures stacked in sequence and electrically connected to each other, and each of the capacitor element structures has a positive electrode portion and a negative electrode portion. The insulating package body is configured to encapsulate the capacitor element structures. The electrode assembly includes a first electrode structure and a second electrode structure, in which the first electrode structure is configured to cooperate with the insulating package body and electrically connected to the positive electrode portion of the capacitor element structure, and the second electrode structure is configured to cooperate with the insulating package body and electrically connected to the negative electrode portion of the capacitor element structure. Each of the capacitor element structures includes an oxide layer, the oxide layer has a plurality of micro recessed spaces that are irregularly concaved and arranged, and each of the micro recessed spaces is partially filled with an electrolyte substance.

In one of the possible or preferred embodiments, each of the capacitor element structures includes a metal foil, an insulating limiting layer configured to surround a first portion of the metal foil, a conductive polymer layer configured to enclose the first portion of the metal foil and contact the insulating limiting layer, a carbon paste layer configured to enclose the conductive polymer layer and contact the insulating limiting layer, and a silver paste layer configured to enclose the carbon paste layer and contact the insulating limiting layer. A second portion of the metal foil of each of the capacitor element structures is not enclosed by the insulating limiting layer, and the second portions of the metal foils of the capacitor element structures are stacked sequentially or separated from each other. The metal foil has a corroded surface configured as an irregular concave-convex surface, and the oxide layer is formed on the corroded surface of the metal foil. The electrolyte substances that are respectively received in the micro recessed spaces are located between the oxide layer and the conductive polymer layer, thereby reducing or eliminating an unoccupied space formed between the oxide layer and the conductive polymer layer. The electrolyte substance includes a solvent, a lithium salt, and an additive. The solvent is selected from the group consisting of gamma-butyrolactone (GBL), cyclobutane sulfonate, ethylene glycol (EG), diethylene glycol, triethylene glycol, polyethylene glycol, and polypropylene glycol. The lithium salt is selected from the group consisting of lithium hexafluorophosphate (LiPF6) and lithium tetrafluoroborate (LiBF4). The additive is selected from the group consisting of a film-forming additive, a high and low temperature additive, and an overcharge protection additive.

In one of the possible or preferred embodiments, the capacitor assembly packaging structure is configured to be sealed inside a moisture-resistant packaging assembly. The moisture-resistant packaging assembly includes an external carrier substrate, an external covering casing disposed on the external carrier substrate, and an external conductive pin structure passing through the external carrier substrate. The external carrier substrate, the external covering casing, and the external conductive pin structure are airtightly cooperated with each other, and the external carrier substrate and the external conductive pin structure are insulated from each other. The external conductive pin structure of the moisture-resistant packaging assembly includes a first external conductive pin and a second external conductive pin, and the first electrode structure and the second electrode structure of the electrode assembly of the capacitor assembly packaging structure are electrically connected to the first external conductive pin and the second external conductive pin of the external conductive pin structure of the moisture-resistant packaging assembly, respectively. The external carrier substrate and the external covering casing are airtightly cooperated with each other through a first moisture-resistant component, and the external carrier substrate and the external conductive pin structure are airtightly cooperated with each other through two second moisture-resistant components. The moisture-resistant packaging assembly further includes a detachable insulating material disposed between the capacitor assembly packaging structure and the external covering casing to prevent the electrode assembly from contacting the external covering casing.

Therefore, in the capacitor element structure provided by the present disclosure, by virtue of “the metal foil having an oxide layer,” “the insulating limiting layer being configured to be disposed around the metal foil,” “the conductive polymer layer being configured to enclose a portion of the metal foil and contact the insulating limiting layer,” “the carbon paste layer being configured to enclose the conductive polymer layer and contact the insulating limiting layer,” “the silver paste layer being configured to enclose the carbon paste layer and contact the insulating limiting layer,” “the oxide layer having a plurality of micro recessed spaces that are irregularly concaved and arranged” and “each of the micro recessed spaces being partially filled with an electrolyte substance,” the electrical properties (such as electrostatic capacitance) of the capacitor element structure can be improved or increased.

Furthermore, in the capacitor assembly packaging structure and the electronic device provided by the present disclosure, by virtue of “the capacitor assembly including a plurality of capacitor element structures stacked in sequence and electrically connected to each other,” “the insulating package body being configured to encapsulate the capacitor element structures,” “the first electrode structure being configured to cooperate with the insulating package body and electrically connected to the positive electrode portion of the capacitor element structure,” “the second electrode structure being configured to cooperate with the insulating package body and electrically connected to the negative electrode portion of the capacitor element structure,” “the oxide layer having a plurality of micro recessed spaces that are irregularly concaved and arranged” and “each of the micro recessed spaces being partially filled with an electrolyte substance,” the electrical properties (such as electrostatic capacitance) of the capacitor element structure can be improved or increased.

These and other aspects of the present disclosure will become apparent from the following description of the embodiment taken in conjunction with the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic cross-sectional view of a metal foil having an oxide layer according to a first embodiment of the present disclosure;

FIG. 2 is a schematic enlarged view of part II of FIG. 1;

FIG. 3 is a schematic cross-sectional view of a plurality of micro recessed spaces filled with electrolyte substances according to the first embodiment of the present disclosure;

FIG. 4 is a schematic cross-sectional view of the micro recessed spaces partially filled with a conductive polymer layer according to the first embodiment of the present disclosure;

FIG. 5 is a schematic cross-sectional view of a capacitor element structure according to the first embodiment of the present disclosure;

FIG. 6 is a schematic cross-sectional view of a capacitor assembly packaging structure according to a second embodiment of the present disclosure;

FIG. 7 is a schematic cross-sectional view of the capacitor assembly packaging structure according to a third embodiment of the present disclosure;

FIG. 8 is a schematic cross-sectional view of the capacitor assembly packaging structure according to a fourth embodiment of the present disclosure;

FIG. 9 is a schematic cross-sectional view of the capacitor assembly packaging structure configured to be sealed within a moisture-resistant packaging assembly according to a fifth embodiment of the present disclosure;

FIG. 10 is a schematic cross-sectional view of the capacitor assembly packaging structure configured to be sealed within the moisture-resistant packaging assembly according to a sixth embodiment of the present disclosure; and

FIG. 11 is a functional block diagram of an electronic device according to a seventh embodiment of the present disclosure.

### DETAILED DESCRIPTION OF THE EXEMPLARY EMBODIMENTS

The present disclosure is more particularly described in the following embodiments and examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” may include plural reference, and the meaning of “in” may include “in” and “on. ” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

Referring to FIG. 1 to FIG. 5, a first embodiment of the present disclosure provides a capacitor element structure 10, which may include a metal foil 100 (or any conductive foil), an insulating limiting layer 101 (or an insulating surrounding layer), a conductive polymer layer 102, a carbon paste layer 103 and a silver paste layer 104 (such as a silver layer that is formed by curing and solidifying, or a silver layer that is formed by sintering, in which the silver layer may have an average thickness less than or equal to 1 μm, thereby reducing the overall thickness of the capacitor element structure 10), and the capacitor element structure 10 may have a positive electrode portion P and a negative electrode portion N.

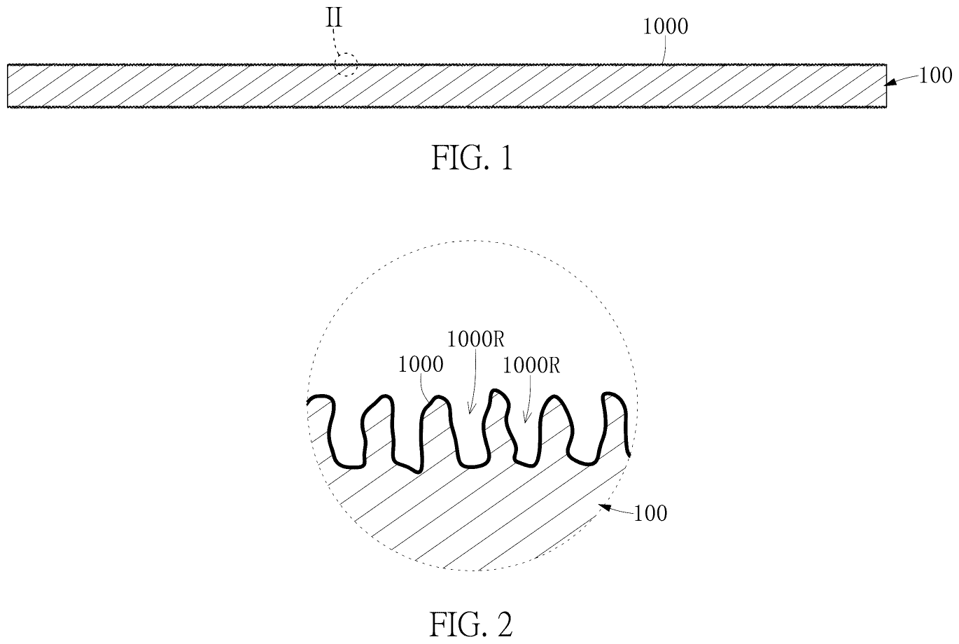

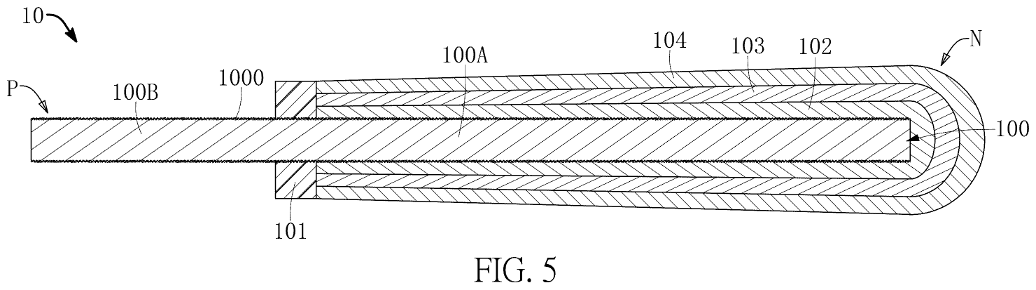

More particularly, referring to FIG. 2 and FIG. 5, an oxide layer 1000 can be formed on an etched surface (or a corroded surface) of the metal foil 100. The insulating limiting layer 101 can be configured to surround the first portion 100A of the metal foil 100, but the insulating limiting layer 101 does not contact the second portion 100B of the metal foil 100 through the insulating limiting layer 101. The conductive polymer layer 102 can be configured to cover (or enclose) the first portion 100A of the metal foil 100 and contact the insulating limiting layer 101, but the conductive polymer layer 102 does not contact the second portion 100B of the metal foil 100 through the insulating limiting layer 101. The carbon paste layer 103 can be configured to cover (or enclose) the conductive polymer layer 102 and contact the insulating limiting layer 101, but the carbon paste layer 103 does not contact the second portion 100B of the metal foil 100 through the insulating limiting layer 101. The silver paste layer 104 can be configured to cover (or enclose) the carbon paste layer 103 and contact the insulating limiting layer 101, but the silver paste layer 104 does not contact the second portion 100B of the metal foil 100 through the insulating limiting layer 101.

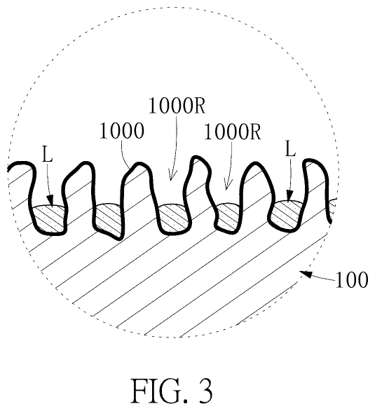

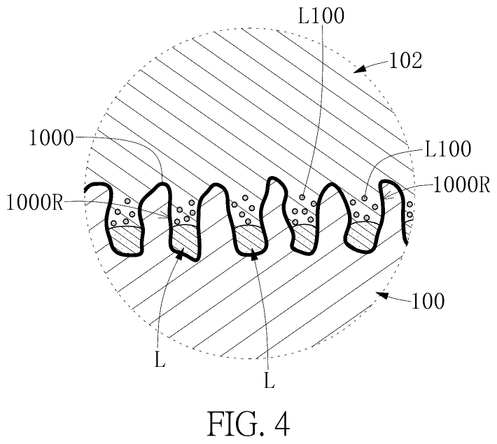

More particularly, referring to FIG. 2, FIG. 3 and FIG. 4, each capacitor element structure 10 at least may include an oxide layer 1000 that is formed on an etched surface (or a corroded surface) of the metal foil 100, and the metal foil 100 may have a corroded surface configured as an irregular concave-convex surface, so that the oxide layer 1000 may have a plurality of micro recessed spaces 1000R (micro-concave spaces) that are irregularly concaved and arranged (irregular concave variations). In addition, each of the micro recessed spaces 1000R can be partially filled with an electrolyte substance L (or an electrolyte material), and the electrolyte substances L that are respectively received in the micro recessed spaces 1000R can be located between the oxide layer 1000 and the conductive polymer layer 102, thereby reducing or eliminating an unoccupied space (such as voids that can be large holes or empty spaces) formed between the oxide layer 1000 and the conductive polymer layer 102. Therefore, the first embodiment of the present disclosure can provide a capacitor element structure 10 that can improve or increase the electrical properties (such as electrostatic capacitance) of the capacitor element structure 10 by using the electrolyte substances L and reducing (or eliminating) unoccupied spaces (e.g., voids).

For example, the metal foil 100 can be an aluminum foil, a copper foil or any type of conductive foil, and the metal foil 100 has a corrosion layer formed on the surface thereof and an oxide layer 1000 formed on the corrosion layer. Furthermore, a second portion 100B of the metal foil 100 of each capacitor element structure 10 is not enclosed by the insulating limiting layer 101. Moreover, the insulating limiting layer 101 may be silicone, epoxy or any type of insulating material, and the conductive polymer layer 102 may be polyacetylene (PA), polypyrrole (PPy), polythiophene (PT), polyaniline (PANI), poly(p-phenylene) (PPP), or poly(phenylene vinylene) (PPV) mixed with a plurality of conductive particles, or the conductive polymer layer 102 may be polyphenylene sulfide, polypyrrole, polythiophene, polyphenylene, or polythiazole mixed with a plurality of conductive particles. In addition, the electrolyte substance L may include a solvent, a lithium salt, and an additive, in which the solvent can be selected from the group consisting of gamma-butyrolactone (GBL), cyclobutane sulfonate, ethylene glycol (EG), diethylene glycol, triethylene glycol, polyethylene glycol, and polypropylene glycol, and the lithium salt can be selected from the group consisting of lithium hexafluorophosphate (LiPF6) and lithium tetrafluoroborate (LiBF4), and the additive can be selected from the group consisting of a film-forming additive, a high and low temperature additive, and an overcharge protection additive. However, the aforementioned details are disclosed for exemplary purposes only, and are not meant to limit the scope of the present disclosure.

It should be noted that, for example, referring to FIG. 3 and FIG. 4, the electrolyte substance L and the conductive polymer layer 102 can be sequentially filled into the micro recessed spaces 1000R of the oxide layer 1000, and each the electrolyte substance L has at least one embedded portion 100L (or infiltration material) penetrating into (or spilled into) the conductive polymer layer 102 inside the corresponding micro recessed space 1000R. Alternatively, in another one of the feasible embodiments, the conductive polymer layer 102 has a predetermined porosity, so that the conductive polymer layer 102 can be first filled into the micro recessed spaces 1000R of the oxide layer 1000 (in this case, multiple voids are formed between the conductive polymer layer 102 and the oxide layer 1000). Then, the electrolyte substance L can be filled into the micro recessed spaces 1000R of the oxide layer 1000 by penetrating the conductive polymer layer 102 (i.e., filling the multiple voids), and each the electrolyte substance L has at least one embedded portion 100L (or infiltration material) penetrating into (or spilled into) the conductive polymer layer 102 inside the corresponding micro recessed space 1000R. Therefore, each micro recessed space 1000R can be configured to receive the corresponding electrolyte substance L and the corresponding part of the conductive polymer layer 102 at the same time. However, the aforementioned details are disclosed for exemplary purposes only, and are not meant to limit the scope of the present disclosure.

### Second Embodiment

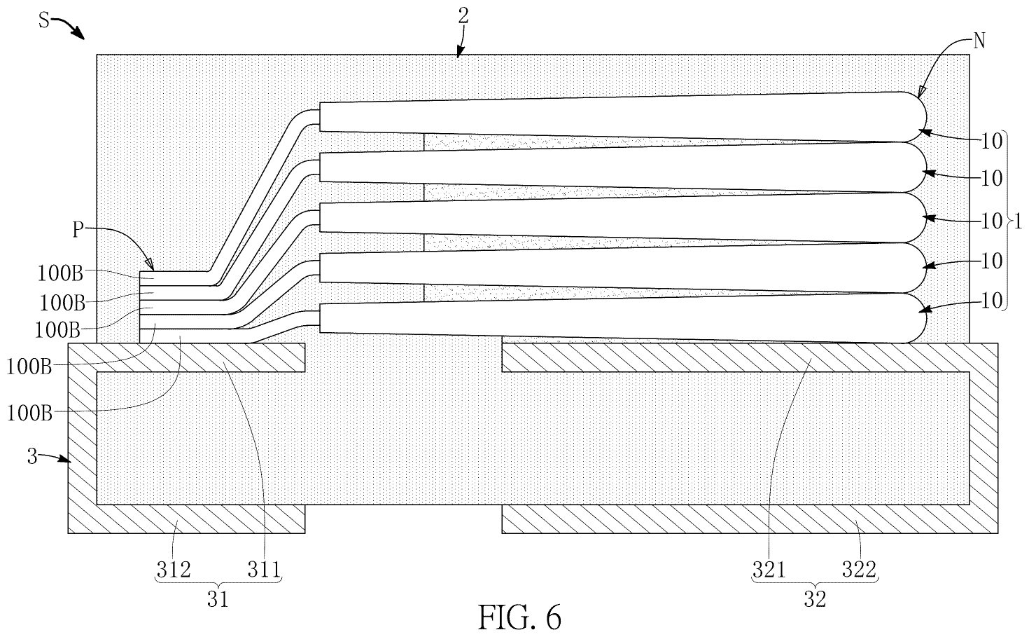

Referring to FIG. 6, a second embodiment of the present disclosure provides a capacitor assembly packaging structure S, which includes a capacitor assembly 1, an insulating package body 2 and an electrode assembly 3. The capacitor assembly 1 may include a plurality of capacitor element structures 10 (such as any capacitor element structure 10 provided in the first embodiment) stacked in sequence and electrically connected to each other, and each capacitor element structure 10 may have a positive electrode portion P and a negative electrode portion N. It should be noted that the second portions 100B of the metal foils 100 of the capacitor element structures 10 can be stacked in sequence.

Furthermore, as shown in FIG. 6, the insulating package body 2 can be configured to encapsulate or enclose the capacitor element structures 10. For example, in one feasible or preferred embodiment, the insulating package body 2 may be made of silicone, epoxy or any type of insulating material. However, the aforementioned details are disclosed for exemplary purposes only, and are not meant to limit the scope of the present disclosure.

Moreover, as shown in FIG. 6, the electrode assembly 3 may include a first electrode structure 31 and a second electrode structure 32, the first electrode structure 31 can be configured to cooperate with the insulating package body 2 and electrically connected to the positive electrode portion P of the capacitor element structure 10, and the second electrode structure 32 can be configured to cooperate with the insulating package body 2 and electrically connected to the negative electrode portion N of the capacitor element structure 10. For example, in one of the feasible embodiments, the electrode assembly 3 can be configured as a conductive pin assembly (or a lead frame assembly). More particularly, when the electrode assembly 3 can be configured as the conductive pin assembly, the first electrode structure 31 of the electrode assembly 3 may include a first embedded portion 311 covered (or enclosed) by the insulating package body 2 and a first exposed portion 312 connected to the first embedded portion 311 and exposed from the insulating package body 2, the first embedded portion 311 of the first electrode structure 31 can be electrically connected to the positive electrode portion P of the capacitor element structure 10 (such as through a conductive material), and the first exposed portion 312 of the first electrode structure 31 can extend along an outer surface of the insulating package body 2. In addition, when the electrode assembly 3 is configured as the conductive pin assembly, the second electrode structure 32 of the electrode assembly 3 may include a second embedded portion 321 covered (or enclosed) by the insulating package body 2 and a second exposed portion 322 connected to the second embedded portion 321 and exposed from the insulating package body 2, the second embedded portion 321 of the second electrode structure 32 can be electrically connected to the negative electrode portion N of the capacitor element structure 10 (such as through a conductive material), and the second exposed portion 322 of the second electrode structure 32 can extend along the outer surface of the insulating package body 2. However, the aforementioned details are disclosed for exemplary purposes only, and are not meant to limit the scope of the present disclosure.

### Third Embodiment

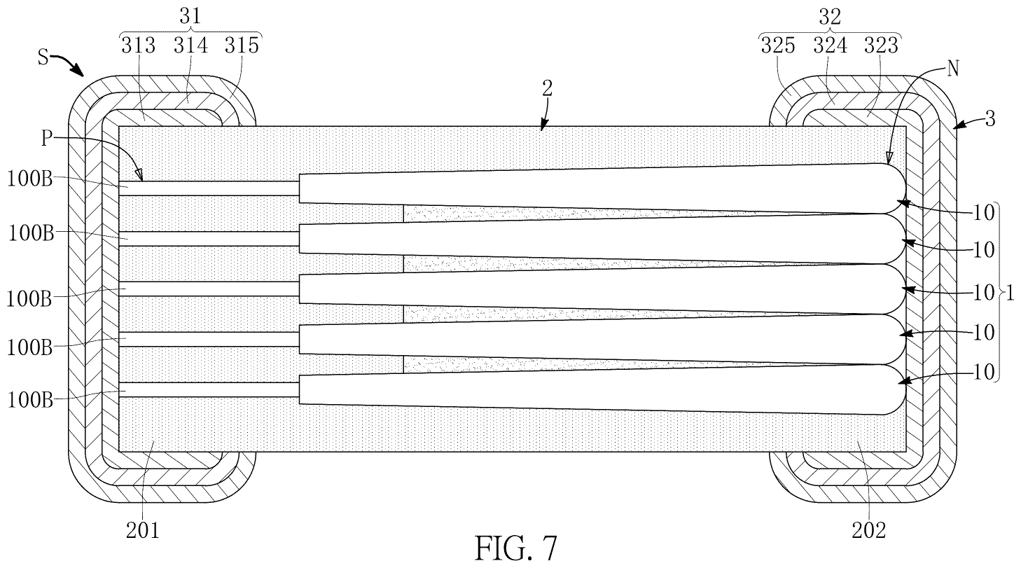

Referring to FIG. 7, a third embodiment of the present disclosure provides a capacitor assembly packaging structure S, which includes a capacitor assembly 1, an insulating package body 2 and an electrode assembly 3. Comparing FIG. 7 with FIG. 6, the main difference between the third embodiment and the second embodiment is as follows: in the third embodiment, the electrode assembly 3 can be configured as a terminal electrode assembly (or a lateral terminal assembly), and the second portions 100B of the metal foils 100 of the capacitor element structures 10 can be separated from each other.

More particularly, when the electrode assembly 3 is configured as the terminal electrode assembly, the first electrode structure 31 of the electrode assembly 3 may include a first inner conductive layer 313 configured to cover (enclose) a first side portion 201 of the insulating package body 2 and electrically contact the positive electrode portion P of the capacitor element structure 10, a first intermediate conductive layer 314 configured to cover (or enclose) the first inner conductive layer 313, and a first outer conductive layer 315 configured to cover (or enclose) the first intermediate conductive layer 314. Moreover, when the electrode assembly 3 is configured as the terminal electrode assembly, the second electrode structure 32 of the electrode assembly 3 may include a second inner conductive layer 323 configured to cover (enclose) a second side portion 202 of the insulating package body 2 and electrically contact the negative electrode portion N of the capacitor element structure 10, a second intermediate conductive layer 324 configured to cover (or enclose) the second inner conductive layer 323, and a second outer conductive layer 325 configured to cover (or enclose) the second intermediate conductive layer 324. For example, the first electrode structure 31 of the electrode assembly 3 can be configured as a first multi-layer conductive layer that can be selected from NiCr, NiSn, Cu, Ag and Ni, and the second electrode structure 32 of the electrode assembly 3 can be configured as a second multi-layer conductive layer that can be selected from NiCr, NiSn, Cu, Ag and Ni. Furthermore, the first inner conductive layer 313 can be one of a silver-containing material layer (such as an Ag layer) and a copper-containing material layer (such as a Cu layer), the first intermediate conductive layer 314 can be a nickel-containing material layer (such as a Ni layer), and the first outer conductive layer 315 can be a tin-containing material layer (such as a Sn layer). The second inner conductive layer 323 can be one of a silver-containing material layer (such as an Ag layer) and a copper-containing material layer (such as a Cu layer), the second intermediate conductive layer 324 can be a nickel-containing material layer (such as a Ni layer), and the second outer conductive layer 325 can be a tin-containing material layer (such as a Sn layer). However, the aforementioned details are disclosed for exemplary purposes only, and are not meant to limit the scope of the present disclosure.

### Fourth Embodiment

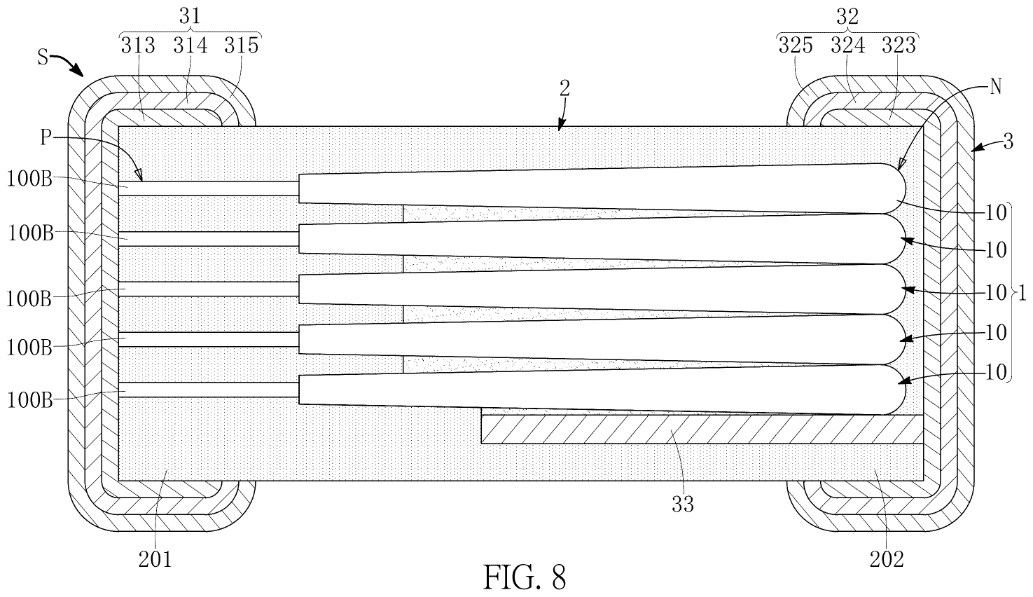

Referring to FIG. 8, a fourth embodiment of the present disclosure provides a capacitor assembly packaging structure S, which includes a capacitor assembly 1, an insulating package body 2 and an electrode assembly 3. Comparing FIG. 8 with FIG. 7, the main difference between the fourth embodiment and the third embodiment is as follows: in the fourth embodiment, when the electrode assembly 3 can be configured as a terminal electrode assembly, the capacitor element structures 10 can be carried by a conductive carrier substrate 33 in advance, and the negative electrode portion N of the capacitor element structure 10 can be electrically connected to the second electrode structure 32 of the electrode assembly 3 through the conductive carrier substrate 33.

### Fifth Embodiment

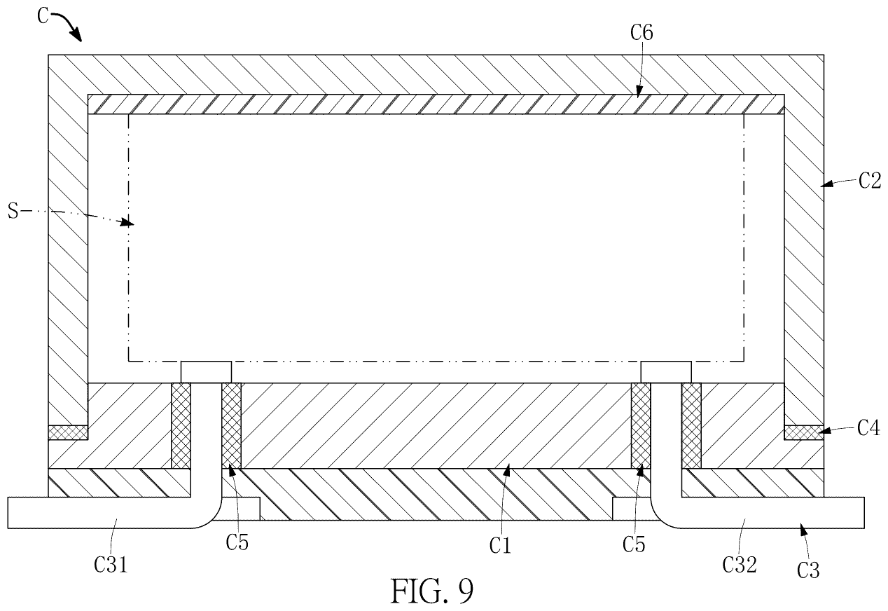

Referring to FIG. 9, a fifth embodiment of the present disclosure provides a capacitor assembly packaging structure S. Comparing FIG. 9 with FIG. 6 (or FIG. 7, or FIG. 8), the main difference between the fifth embodiment and the second embodiment (or the third, or the fourth embodiment) is as follows: in the fifth embodiment, the capacitor assembly packaging structure S can be configured to be sealed inside a moisture-resistant packaging assembly C (or a water vapor blocking assembly), and the moisture-resistant packaging assembly C may include an external carrier substrate C1, an external covering casing C2 disposed on the external carrier substrate C1, and an external conductive pin structure C3 passing through the external carrier substrate C1. For example, the external carrier substrate C1 can be configured as a metal carrier substrate without a ceramic sheet, and the external covering casing C2 can be configured as a metal covering shell or a ceramic covering shell. However, the aforementioned details are disclosed for exemplary purposes only, and are not meant to limit the scope of the present disclosure.

More particularly, as shown in FIG. 9, the external conductive pin structure C3 of the moisture-resistant packaging assembly C may include a first external conductive pin C31 and a second external conductive pin C32, and the first electrode structure and the second electrode structure of the electrode assembly (as shown in FIG. 6 to FIG. 8) of the capacitor assembly packaging structure S can be electrically connected to the first external conductive pin C31 and the second external conductive pin C32 of the external conductive pin structure C3 of the moisture-resistant packaging assembly C, respectively. For example, the first electrode structure and the second electrode structure can be respectively and electrically connected to the first external conductive pin C31 and the second external conductive pin C32 through solder balls, solder paste or any conductive material. However, the aforementioned details are disclosed for exemplary purposes only, and are not meant to limit the scope of the present disclosure.

More particularly, as shown in FIG. 9, the external carrier substrate C1, the external covering casing C2, and the external conductive pin structure C3 can be airtightly (hermetically) cooperated with each other. For example, the external carrier substrate C1 and the external covering casing C2 can be airtightly cooperated with each other through a first moisture-resistant component C4 (such as a first surrounding waterproof strip), and the external carrier substrate C1 and the external conductive pin structure C3 can be airtightly cooperated with each other through two second moisture-resistant components C5 (such as two second surrounding waterproof strips). That is to say, the capacitor assembly packaging structure S can be protected from moisture by the moisture-resistant packaging assembly C, thereby ensuring the electrical characteristics of the capacitor assembly packaging structure S and increasing the service life of the capacitor assembly packaging structure S. However, the aforementioned details are disclosed for exemplary purposes only, and are not meant to limit the scope of the present disclosure.

More particularly, as shown in FIG. 9, the external carrier substrate C1 and the external conductive pin structure C3 can be insulated from each other by any insulating material. In addition, the moisture-resistant packaging assembly C may further include a detachable insulating material C6 disposed between the capacitor assembly packaging structure S and the external covering casing C2 to prevent the electrode assembly from contacting the external covering casing C2. For example, the detachable insulating material C6 can be configured to cover or enclose a portion or all of the electrode assembly of the capacitor assembly packaging structure S. It is worth noting that, especially when the capacitor assembly packaging structure S provided by the third embodiment or the fourth embodiment is configured to be sealed inside the moisture-resistant packaging assembly C, the capacitor assembly packaging structure S can ensure the insulation relationship between the capacitor assembly packaging structure S and the external covering casing C2 through the detachable insulating material C6.

### Sixth Embodiment

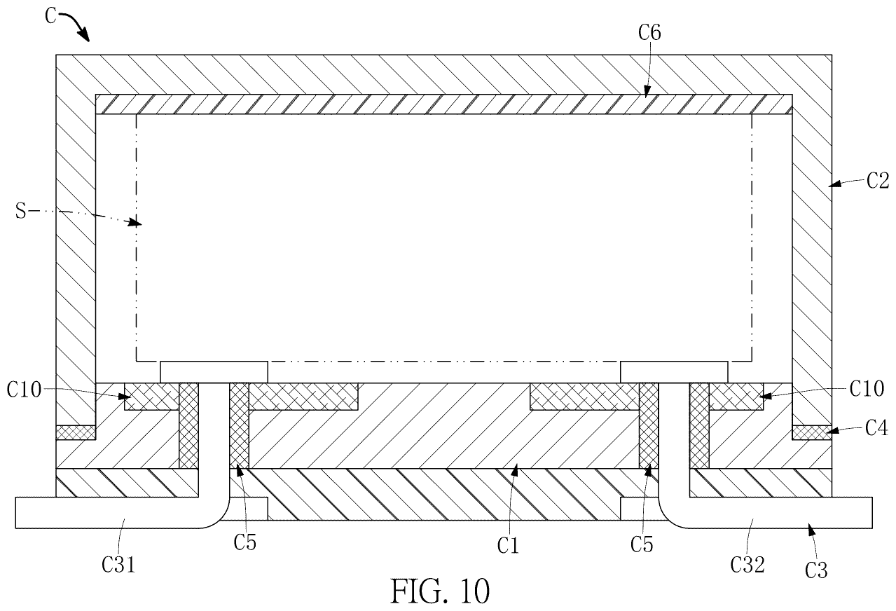

Referring to FIG. 10, a sixth embodiment of the present disclosure provides a capacitor assembly packaging structure S. Comparing FIG. 10 with FIG. 9, the main difference between the sixth embodiment and the fifth embodiment is as follows: in the sixth embodiment, the external carrier substrate C1 can be configured as a metal carrier substrate with a ceramic sheet C10, and the external covering casing C2 can be configured as a metal covering shell or a ceramic covering shell.

### Seventh Embodiment

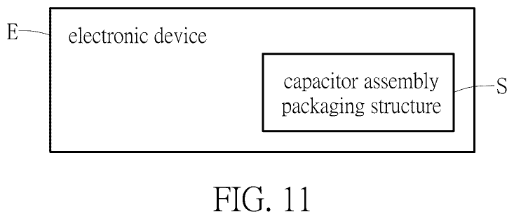

Referring to FIG. 11, a seventh embodiment of the present disclosure provides an electronic device E configured to use a capacitor assembly packaging structure S as provided by one of the second embodiment to the fifth embodiment (as shown in FIG. 6, FIG. 7, FIG. 8 and FIG. 9). For example, the electronic device E may be a portable electronic device (such as a desktop computer, a notebook computer, or a tablet computer) or a mobile device (such as a car, a boat, an airplane, or any other means of transportation). However, the aforementioned details are disclosed for exemplary purposes only, and are not meant to limit the scope of the present disclosure.

### Beneficial Effects of the Embodiments

In conclusion, in the capacitor element structure 10 provided by the present disclosure, by virtue of “the metal foil 100 having an oxide layer 1000,” “the insulating limiting layer 101 being configured to be disposed around the metal foil 100,” “the conductive polymer layer 102 being configured to enclose a portion of the metal foil 100 and contact the insulating limiting layer 101,” “the carbon paste layer 103 being configured to enclose the conductive polymer layer 102 and contact the insulating limiting layer 101,” “the silver paste layer 104 being configured to enclose the carbon paste layer 103 and contact the insulating limiting layer 101,” “the oxide layer 1000 having a plurality of micro recessed spaces 1000R that are irregularly concaved and arranged” and “each of the micro recessed spaces 1000R being partially filled with an electrolyte substance L,” the electrical properties (such as electrostatic capacitance) of the capacitor element structure 10 can be improved or increased.

Furthermore, in the capacitor assembly packaging structure S and the electronic device E provided by the present disclosure, by virtue of “the capacitor assembly 1 including a plurality of capacitor element structures 10 stacked in sequence and electrically connected to each other,” “the insulating package body 2 being configured to encapsulate the capacitor element structures 10,” “the first electrode structure 31 being configured to cooperate with the insulating package body 2 and electrically connected to the positive electrode portion P of the capacitor element structure 10,” “the second electrode structure 32 being configured to cooperate with the insulating package body 2 and electrically connected to the negative electrode portion N of the capacitor element structure 10,” “the oxide layer 1000 having a plurality of micro recessed spaces 1000R that are irregularly concaved and arranged” and “each of the micro recessed spaces 1000R being partially filled with an electrolyte substance L,” the electrical properties (such as electrostatic capacitance) of the capacitor element structure 10 can be improved or increased.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A capacitor element structure, comprising:
a metal foil having an oxide layer;
an insulating limiting layer configured to be disposed around the metal foil;
a conductive polymer layer configured to enclose a portion of the metal foil and contact the insulating limiting layer;
a carbon paste layer configured to enclose the conductive polymer layer and contact the insulating limiting layer; and
a silver paste layer configured to enclose the carbon paste layer and contact the insulating limiting layer;
wherein the oxide layer has a plurality of micro recessed spaces that are irregularly concaved and arranged, and each of the micro recessed spaces is partially filled with an electrolyte substance.

2. The capacitor element structure according to claim 1,
wherein the metal foil has a corroded surface configured as an irregular concave-convex surface, and the oxide layer is formed on the corroded surface of the metal foil;
wherein the electrolyte substances that are respectively received in the micro recessed spaces are located between the oxide layer and the conductive polymer layer, thereby reducing or eliminating an unoccupied space formed between the oxide layer and the conductive polymer layer;
wherein the electrolyte substance includes a solvent, a lithium salt, and an additive;
wherein the solvent is selected from the group consisting of gamma-butyrolactone (GBL), cyclobutane sulfonate, ethylene glycol (EG), diethylene glycol, triethylene glycol, polyethylene glycol, and polypropylene glycol;
wherein the lithium salt is selected from the group consisting of lithium hexafluorophosphate (LiPF6) and lithium tetrafluoroborate (LiBF4);
wherein the additive is selected from the group consisting of a film-forming additive, a high and low temperature additive, and an overcharge protection additive; and
wherein each of the electrolyte substances has at least one embedded portion penetrating into the conductive polymer layer inside a corresponding one of the micro recessed spaces, and each of the micro recessed spaces is configured to receive both the electrolyte substance and a part of the conductive polymer layer.

3. A capacitor assembly packaging structure, comprising:
a capacitor assembly including a plurality of capacitor element structures stacked in sequence and electrically connected to each other, wherein each of the capacitor element structures has a positive electrode portion and a negative electrode portion;
an insulating package body configured to encapsulate the capacitor element structures; and
an electrode assembly including a first electrode structure and a second electrode structure, wherein the first electrode structure is configured to cooperate with the insulating package body and electrically connected to the positive electrode portion of the capacitor element structure, and the second electrode structure is configured to cooperate with the insulating package body and electrically connected to the negative electrode portion of the capacitor element structure;
wherein each of the capacitor element structures includes an oxide layer, the oxide layer has a plurality of micro recessed spaces that are irregularly concaved and arranged, and each of the micro recessed spaces is partially filled with an electrolyte substance.

4. The capacitor assembly packaging structure according to claim 3,
wherein each of the capacitor element structures includes a metal foil, an insulating limiting layer configured to surround a first portion of the metal foil, a conductive polymer layer configured to enclose the first portion of the metal foil and contact the insulating limiting layer, a carbon paste layer configured to enclose the conductive polymer layer and contact the insulating limiting layer, and a silver paste layer configured to enclose the carbon paste layer and contact the insulating limiting layer;
wherein a second portion of the metal foil of each of the capacitor element structures is not enclosed by the insulating limiting layer, and the second portions of the metal foils of the capacitor element structures are stacked sequentially or separated from each other;
wherein the metal foil has a corroded surface configured as an irregular concave-convex surface, and the oxide layer is formed on the corroded surface of the metal foil;
wherein the electrolyte substances that are respectively received in the micro recessed spaces are located between the oxide layer and the conductive polymer layer, thereby reducing or eliminating an unoccupied space formed between the oxide layer and the conductive polymer layer;
wherein the electrolyte substance includes a solvent, a lithium salt, and an additive;
wherein the solvent is selected from the group consisting of gamma-butyrolactone (GBL), cyclobutane sulfonate, ethylene glycol (EG), diethylene glycol, triethylene glycol, polyethylene glycol, and polypropylene glycol;
wherein the lithium salt is selected from the group consisting of lithium hexafluorophosphate (LiPF6) and lithium tetrafluoroborate (LiBF4);
wherein the additive is selected from the group consisting of a film-forming additive, a high and low temperature additive, and an overcharge protection additive;
wherein the capacitor assembly packaging structure is configured to be sealed inside a moisture-resistant packaging assembly;
wherein the moisture-resistant packaging assembly includes an external carrier substrate, an external covering casing disposed on the external carrier substrate, and an external conductive pin structure passing through the external carrier substrate;
wherein the external carrier substrate, the external covering casing, and the external conductive pin structure are airtightly cooperated with each other, and the external carrier substrate and the external conductive pin structure are insulated from each other;
wherein the external conductive pin structure of the moisture-resistant packaging assembly includes a first external conductive pin and a second external conductive pin, and the first electrode structure and the second electrode structure of the electrode assembly of the capacitor assembly packaging structure are electrically connected to the first external conductive pin and the second external conductive pin of the external conductive pin structure of the moisture-resistant packaging assembly, respectively;
wherein the external carrier substrate and the external covering casing are airtightly cooperated with each other through a first moisture-resistant component, and the external carrier substrate and the external conductive pin structure are airtightly cooperated with each other through two second moisture-resistant components;
wherein the moisture-resistant packaging assembly further includes a detachable insulating material disposed between the capacitor assembly packaging structure and the external covering casing to prevent the electrode assembly from contacting the external covering casing; and
wherein each of the electrolyte substances has at least one embedded portion penetrating into the conductive polymer layer inside a corresponding one of the micro recessed spaces, and each of the micro recessed spaces is configured to receive both the electrolyte substance and a part of the conductive polymer layer.

5. The capacitor assembly packaging structure according to claim 3,
wherein the electrode assembly is configured as a conductive pin assembly or a terminal electrode assembly;
wherein, when the electrode assembly is the conductive pin assembly, the first electrode structure of the electrode assembly includes a first embedded portion covered by the insulating package body and a first exposed portion connected to the first embedded portion and exposed from the insulating package body, the first embedded portion of the first electrode structure is electrically connected to the positive electrode portion of the capacitor element structure, and the first exposed portion of the first electrode structure extends along an outer surface of the insulating package body;
wherein, when the electrode assembly is the conductive pin assembly, the second electrode structure of the electrode assembly includes a second embedded portion covered by the insulating package body and a second exposed portion connected to the second embedded portion and exposed from the insulating package body, the second embedded portion of the second electrode structure is electrically connected to the negative electrode portion of the capacitor element structure, and the second exposed portion of the second electrode structure extends along the outer surface of the insulating package body;
wherein, when the electrode assembly is the terminal electrode assembly, the first electrode structure of the electrode assembly includes a first inner conductive layer configured to cover a first side portion of the insulating package body and electrically contact the positive electrode portion of the capacitor element structure, a first intermediate conductive layer configured to cover the first inner conductive layer, and a first outer conductive layer configured to cover the first intermediate conductive layer, and the first electrode structure of the electrode assembly is configured as a first multi-layer conductive layer selected from NiCr, NiSn, Cu, Ag and Ni; and
wherein, when the electrode assembly is the terminal electrode assembly, the second electrode structure of the electrode assembly includes a second inner conductive layer configured to cover a second side portion of the insulating package body and electrically contact the negative electrode portion of the capacitor element structure, a second intermediate conductive layer configured to cover the second inner conductive layer, and a second outer conductive layer configured to cover the second intermediate conductive layer, and the second electrode structure of the electrode assembly is configured as a second multi-layer conductive layer selected from NiCr, NiSn, Cu, Ag and Ni.

6. The capacitor assembly packaging structure according to claim 3,
wherein the electrode assembly is configured as a terminal electrode assembly;
wherein the first electrode structure of the electrode assembly includes a first inner conductive layer configured to cover a first side portion of the insulating package body and electrically contact the positive electrode portion of the capacitor element structure, a first intermediate conductive layer configured to cover the first inner conductive layer, and a first outer conductive layer configured to cover the first intermediate conductive layer, and a second outer conductive layer configured to cover the second intermediate conductive layer, and the first electrode structure of the electrode assembly is configured as a first multi-layer conductive layer selected from NiCr, NiSn, Cu, Ag, and Ni;
wherein the second electrode structure of the electrode assembly includes a second inner conductive layer configured to cover a second side portion of the insulating package body and electrically contact the negative electrode portion of the capacitor element structure, a second intermediate conductive layer configured to cover the second inner conductive layer, and the second electrode structure of the electrode assembly is configured as a second multi-layer conductive layer selected from NiCr, NiSn, Cu, Ag, and Ni; and
wherein the capacitor element structures are carried by a conductive carrier substrate, and the negative electrode portion of the capacitor element structure is electrically connected to the second electrode structure of the electrode assembly through the conductive carrier substrate.

7. An electronic device configured to use a capacitor assembly packaging structure, characterized in that the capacitor assembly packaging structure comprises:
a capacitor assembly including a plurality of capacitor element structures stacked in sequence and electrically connected to each other, wherein each of the capacitor element structures has a positive electrode portion and a negative electrode portion;
an insulating package body configured to encapsulate the capacitor element structures; and
an electrode assembly including a first electrode structure and a second electrode structure, wherein the first electrode structure is configured to cooperate with the insulating package body and electrically connected to the positive electrode portion of the capacitor element structure, and the second electrode structure is configured to cooperate with the insulating package body and electrically connected to the negative electrode portion of the capacitor element structure;
wherein each of the capacitor element structures includes an oxide layer, the oxide layer has a plurality of micro recessed spaces that are irregularly concaved and arranged, and each of the micro recessed spaces is partially filled with an electrolyte substance.

8. The capacitor assembly packaging structure according to claim 7,
wherein each of the capacitor element structures includes a metal foil, an insulating limiting layer configured to surround a first portion of the metal foil, a conductive polymer layer configured to enclose the first portion of the metal foil and contact the insulating limiting layer, a carbon paste layer configured to enclose the conductive polymer layer and contact the insulating limiting layer, and a silver paste layer configured to enclose the carbon paste layer and contact the insulating limiting layer;
wherein a second portion of the metal foil of each of the capacitor element structures is not enclosed by the insulating limiting layer, and the second portions of the metal foils of the capacitor element structures are stacked sequentially or separated from each other;
wherein the metal foil has a corroded surface configured as an irregular concave-convex surface, and the oxide layer is formed on the corroded surface of the metal foil;
wherein the electrolyte substances that are respectively received in the micro recessed spaces are located between the oxide layer and the conductive polymer layer, thereby reducing or eliminating an unoccupied space formed between the oxide layer and the conductive polymer layer;
wherein the electrolyte substance includes a solvent, a lithium salt, and an additive;
wherein the solvent is selected from the group consisting of gamma-butyrolactone (GBL), cyclobutane sulfonate, ethylene glycol (EG), diethylene glycol, triethylene glycol, polyethylene glycol, and polypropylene glycol;
wherein the lithium salt is selected from the group consisting of lithium hexafluorophosphate (LiPF6) and lithium tetrafluoroborate (LiBF4);
wherein the additive is selected from the group consisting of a film-forming additive, a high and low temperature additive, and an overcharge protection additive;
wherein the capacitor assembly packaging structure is configured to be sealed inside a moisture-resistant packaging assembly;
wherein the moisture-resistant packaging assembly includes an external carrier substrate, an external covering casing disposed on the external carrier substrate, and an external conductive pin structure passing through the external carrier substrate;
wherein the external carrier substrate, the external covering casing, and the external conductive pin structure are airtightly cooperated with each other, and the external carrier substrate and the external conductive pin structure are insulated from each other;
wherein the external carrier substrate is configured as a metal carrier substrate with or without a ceramic sheet, and the external covering casing is configured as a metal covering shell or a ceramic covering shell;
wherein the external conductive pin structure of the moisture-resistant packaging assembly includes a first external conductive pin and a second external conductive pin, and the first electrode structure and the second electrode structure of the electrode assembly of the capacitor assembly packaging structure are electrically connected to the first external conductive pin and the second external conductive pin of the external conductive pin structure of the moisture-resistant packaging assembly, respectively;
wherein the external carrier substrate and the external covering casing are airtightly cooperated with each other through a first moisture-resistant component, and the external carrier substrate and the external conductive pin structure are airtightly cooperated with each other through two second moisture-resistant components;
wherein the moisture-resistant packaging assembly further includes a detachable insulating material disposed between the capacitor assembly packaging structure and the external covering casing to prevent the electrode assembly from contacting the external covering casing; and
wherein each of the electrolyte substances has at least one embedded portion penetrating into the conductive polymer layer inside a corresponding one of the micro recessed spaces, and each of the micro recessed spaces is configured to receive both the electrolyte substance and a part of the conductive polymer layer.

9. The capacitor assembly packaging structure according to claim 7,
wherein the electrode assembly is configured as a conductive pin assembly or a terminal electrode assembly;
wherein, when the electrode assembly is the conductive pin assembly, the first electrode structure of the electrode assembly includes a first embedded portion covered by the insulating package body and a first exposed portion connected to the first embedded portion and exposed from the insulating package body, the first embedded portion of the first electrode structure is electrically connected to the positive electrode portion of the capacitor element structure, and the first exposed portion of the first electrode structure extends along an outer surface of the insulating package body;
wherein, when the electrode assembly is the conductive pin assembly, the second electrode structure of the electrode assembly includes a second embedded portion covered by the insulating package body and a second exposed portion connected to the second embedded portion and exposed from the insulating package body, the second embedded portion of the second electrode structure is electrically connected to the negative electrode portion of the capacitor element structure, and the second exposed portion of the second electrode structure extends along the outer surface of the insulating package body;
wherein, when the electrode assembly is the terminal electrode assembly, the first electrode structure of the electrode assembly includes a first inner conductive layer configured to cover a first side portion of the insulating package body and electrically contact the positive electrode portion of the capacitor element structure, a first intermediate conductive layer configured to cover the first inner conductive layer, and a first outer conductive layer configured to cover the first intermediate conductive layer, and the first electrode structure of the electrode assembly is configured as a first multi-layer conductive layer selected from NiCr, NiSn, Cu, Ag and Ni; and
wherein, when the electrode assembly is the terminal electrode assembly, the second electrode structure of the electrode assembly includes a second inner conductive layer configured to cover a second side portion of the insulating package body and electrically contact the negative electrode portion of the capacitor element structure, a second intermediate conductive layer configured to cover the second inner conductive layer, and a second outer conductive layer configured to cover the second intermediate conductive layer, and the second electrode structure of the electrode assembly is configured as a second multi-layer conductive layer selected from NiCr, NiSn, Cu, Ag and Ni.

10. The capacitor assembly packaging structure according to claim 7,
wherein the electrode assembly is configured as a terminal electrode assembly;
wherein the first electrode structure of the electrode assembly includes a first inner conductive layer configured to cover a first side portion of the insulating package body and electrically contact the positive electrode portion of the capacitor element structure, a first intermediate conductive layer configured to cover the first inner conductive layer, and a first outer conductive layer configured to cover the first intermediate conductive layer, and a second outer conductive layer configured to cover the second intermediate conductive layer, and the first electrode structure of the electrode assembly is configured as a first multi-layer conductive layer selected from NiCr, NiSn, Cu, Ag, and Ni;
wherein the second electrode structure of the electrode assembly includes a second inner conductive layer configured to cover a second side portion of the insulating package body and electrically contact the negative electrode portion of the capacitor element structure, a second intermediate conductive layer configured to cover the second inner conductive layer, and the second electrode structure of the electrode assembly is configured as a second multi-layer conductive layer selected from NiCr, NiSn, Cu, Ag, and Ni; and
wherein the capacitor element structures are carried by a conductive carrier substrate, and the negative electrode portion of the capacitor element structure is electrically connected to the second electrode structure of the electrode assembly through the conductive carrier substrate.
